(19) United States
(12) Patent Application Publication
(10) Pub. No.: US 2022/0034499 A1
(43) Pub. Date: Feb. 3, 2022

(54) Suction Cup Candle Holder

(71) Applicant: Lyle Addicks, Allen, TX (US)

(72) Inventor: Lyle Addicks, Allen, TX (US)

(21) Appl. No.: 17/087,990

(22) Filed: Nov. 3, 2020

Related U.S. Application Data
(63) Continuation of application No. 16/947,449, filed on Aug. 2, 2020.

(51) Int. Cl. F21V 35/00; F21S 13/12

(52) U.S. Cl. CPC F21V 35/00; F21S 13/12

(57) ABSTRACT

A candle holder which includes a suction cup centrally located on an axis and having opposite top and bottom sides, said bottom side having a concave shape and configured to adhere to a flat surface by a creating a vacuum when pressed against the surface, a cylindrical body extending along the axis upward from the top side of said suction cup, and a face at the end of said body located opposite the suction cup, said face lying flat in a plane perpendicular with said axis and forming a centrally located orifice for a bore that extends along the axis into said body for receiving a candle.

### CROSS-REFERENCE TO RELATED APPLICATIONS

This application is a continuation-in-part of application Ser. No. 16/947,449 filed Aug. 2, 2020. Applicant claims priority in part pursuant to 35 U.S.C. § 120 and incorporates Ser. No. 16/947,449 by reference herein.

### BACKGROUND OF THE INVENTION

### 1. Field of the Invention

The present invention is in the field of candle holders.

### 2. Background

Candles are commonly displayed on cakes for birthday and other celebratory occasions. Generally, the candles are stuck into the cake then lit. During a birthday celebration the birthday boy or girl blows out the candles, potentially contaminating the cake by projecting droplets of saliva onto it. Other party goers are then subject to exposure to any viruses or colds that might be passed through eating the contaminated cake.

Further disadvantages of displaying candles directly on a cake include the potential for candle wax to drip onto the cake. Moreover, when removed from the cake, candles often leave undesirable holes in the icing, diminishing the cake's aesthetics.

Some attempted solutions have tried securing a candle to a cake holder by melting the bottom of the candle then contacting the melted end with the cake holder while the candle wax dries. This attempted solution has not sufficiently addressed the discussed drawbacks owing to the instability of the bond to the cake holder and the potential to melt the holder itself when the melted candle contacts the holder. Additionally, once attached the melted candles are difficult to reposition.

Other solutions have tried utilizing a cake holder which has preset, permanent indentions in which candles can be placed. Similarly, this has not sufficiently addressed the discussed drawbacks owing to its inability to permit adjustable customization of the candle display. Furthermore, unused indentions in the cake holder interfere with viewing the cake's aesthetics.

Therefore, what is clearly needed is a candle holder that solves the problems mentioned above.

### SUMMARY OF THE INVENTION

In one embodiment of the invention a candle holder for displaying a candle on a cake cover is provided, comprising a suction cup centrally located on an axis and having opposite top and bottom sides, said bottom side having a concave shape and configured to adhere to a flat surface by a creating a vacuum when pressed against the surface, a cylindrical body extending along the axis upward from the top side of said suction cup, and a face at the end of said body located opposite the suction cup, said face forming a centrally located orifice for a bore that extends into said body for receiving a candle.

In one embodiment the candle holder's bore extends vertically and runs parallel to the axis that runs through the suction cup and body. Alternatively, the bore may have tapered, reverse tapered, partial taper, universal, or spherical configurations for reception of candles with differing diameters or an assortment of adapters.

In one embodiment of the invention the candle holder's orifice and bore are configured to receive an adaptor comprising a body on an axis, a top, and a bottom, said top having a face lying flat in a plane perpendicular with said axis and forming a centrally located orifice for a bore that extends along the axis and into said adapter's body, wherein said adapter's body is arranged for insertion into the candle holder's orifice and bore with the adapter's top extending outwardly. Also, in one embodiment said adapter's orifice and bore are adapted to receive a candle having a smaller diameter than said candle holder's orifice and bore. In another embodiment said adapter's orifice and bore are configured to receive a spike protruding from the bottom of a candle.

For use with a cake cover that has a non-parallel surface, one embodiment of the invention employs an articulating adapter which utilizes a ball and spherical bore to permit a candle to be supported vertically on a sloped surface.

In yet another embodiment of the invention a decorative cake topper forms a centrally located orifice configured to pass over the candle holder and rest on the exterior of the candle holder's body.

### BRIEF DESCRIPTION OF THE DRAWINGS

FIG. 1 is a perspective view of a candle holder according to an embodiment of the present invention showing its candle receiving orifice disposed uppermost.

FIG. 2 is a vertical sectional view, taken on the plane A-A, of the candle holder of FIG. 1.

FIG. 3 is a perspective view of the candle holder of FIG. 1 wherein a candle is inserted into the holder.

FIG. 4 is a vertical sectional view, taken on the plane A-A, of the candle holder of FIG. 1 wherein a candle is inserted into the holder.

FIG. 5 is a top perspective view of the candle holder of FIG. 1 wherein the candle holder is attached to a cake cover.

FIG. 6 is a side perspective view of the candle holder of FIG. 1 wherein the candle holder is attached to a cake cover.

FIG. 7 is a perspective view of a candle adapter with its candle receiving orifice disposed uppermost.

FIG. 8 is a vertical sectional view, taken on the plane B-B, of the candle adapter of FIG. 7.

FIG. 9 is a perspective view of the candle adapter of FIG. 7 inserted into the candle holder of FIG. 1.

FIG. 10 is a side view of a candle having a spiked base.

FIG. 11 is a perspective view of a second candle adapter according to another embodiment of the present invention.

FIG. 12 is a sectional view of the candle adapter of FIG. 11, taken on the plane C-C, inserted into the candle holder and supporting a spiked base candle.

FIG. 13 is a perspective view of a candle holder with a pull tab.

FIG. 14 is a perspective view of a double-sided adhesive pad.

FIG. 15 is a perspective view of a candle holder with a double-sided adhesive pad attached to the bottom side of the suction cup.

FIG. 16 is a perspective view of a decorative cake topper.

FIG. 17 is vertical section view, taken on the plane A-A, of the candle holder of FIG. 1 supporting the decorative cake topper of FIG. 16, taken on the plane D-D.

FIG. 18 is a perspective view of an articulating adapter.

FIG. 19 is a vertical section view, taken on the plane E-E, of the articulating adapter of FIG. 18.

FIG. 20 is a vertical section view, taken on the plane E-E, of the articulating adapter of FIG. 18 holding a candle and positioned inside the candle holder of FIG. 1, taken on the plane A-A.

FIG. 21 is a vertical section view, taken on the plane E-E, of the articulating adapter of FIG. 18 holding a candle positioned inside the candle holder of FIG. 1, taken on the plane A-A, and rotated to reposition the candle.

FIG. 22. is a perspective view of the articulating adapter of FIG. 21 holding a candle and attached to a dome shaped cake cover.

FIG. 23 is a perspective view of a through hole adapter.

FIG. 24 is a vertical section view, taken on the plane F-F, of the through hole adapter of FIG. 23.

FIG. 25 is a vertical section view of the candle holder having a universal holder bore configuration.

FIG. 26 is a vertical section view of the candle holder having a reverse taper bore configuration.

FIG. 27 is a vertical section view of the candle holder of FIG. 26 supporting the articulating adapter of FIG. 19.

FIG. 28 is a vertical section view of the candle holder having a spherical bore configuration.

FIG. 29 is a vertical section view of the candle holder of FIG. 28 supporting the articulating adapter of FIG. 19.

FIG. 30 is a perspective view of a universal adapter.

FIG. 31 is a perspective view of the universal adapter of FIG. 30 supporting a candle.

FIG. 32. is a vertical section view, taken on the plane G-G, of the universal adapter and candle of FIG. 31.

FIG. 33 is a vertical section view, taken on the plane G-G, of the universal adapter and candle of FIG. 31 inserted into a candle holder with a partially tapered bore.

FIG. 34 is a perspective view of a flat base candle holder.

FIG. 35 is a vertical section view, taken on the plane H-H, of the flat base candle holder of FIG. 34.

### DETAILED DESCRIPTION OF THE INVENTION

The inventor provides a candle holder for suction attachment to a cake cover enabling candles to be blown out with reduced likelihood of spreading viruses or colds. The present invention is described in enabling detail in the following examples, which may represent more than one embodiment of the present invention.

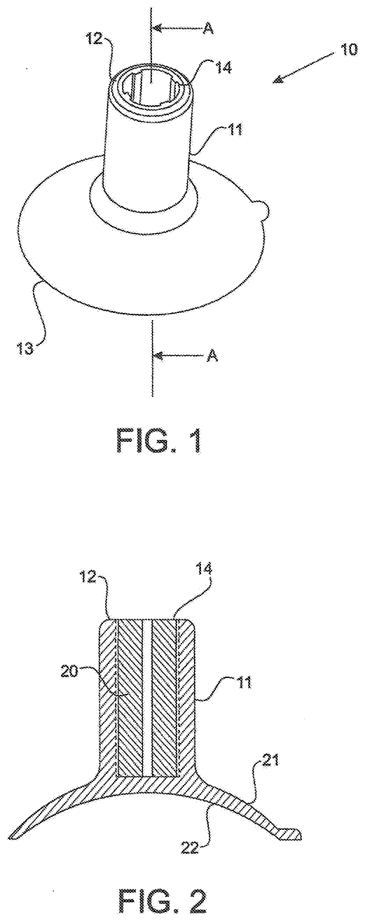

Referring to FIG. 1, the candle holder 10 comprises a body 11, a face 12, and a suction cup 13. FIG. 1 is a perspective view of a candle holder 10 according to an embodiment of the present invention showing the face 12 disposed uppermost. The face 12 and suction cup 13 are connected by the body 11 and molded as a one-piece structure. The candle holder 10 is symmetric about an axis, represented as A-A. At its central portion along axis A-A, the face 12 forms an orifice 14 for reception of a candle.

The one-piece candle holder 10 can be molded from any soft, flexible plastic material. While polyvinyl chloride is the preferred material, it can be produced from silicone, neoprene, Kraton, or other polymers. Additionally, all the embodiments and attachments set forth below may be molded from flexible plastics.

The face 12 is formed from one end of the body 11 opposite the suction cup 13. Moreover, the face 12 lies flat in a plane parallel to the plane on which the suction cup 13 is positioned. In other words, the face 12 lies in a plane perpendicular to the axis A-A. It is not essential that the face 12 is flat and may take on other shapes in other embodiments of the invention.

FIG. 2 is a vertical sectional view, taken on the plane A-A, of the candle holder of FIG. 1. As shown in FIG. 2, a bore 20 begins at the orifice 14 and extends straight downward into the body 11. Like the body 11, the bore 20 is vertical, circular, and runs parallel to axis A-A. In the described embodiment, the bore is configured to receive and support a birthday candle. For increased support, the bore's 20 diameter should be slightly smaller than the diameter of the desired candle. This configuration and the candle holder's elasticity promote deflection in the body 11 which acts to secure the candle in the holder. This embodiment of the candle holder employs a straight bore configuration; however, it is not essential that the bore 10 be straight and may take on other configurations to accommodate different sized candles or to receive various adapters.

Although the orifice 14 and bore 20 in FIGS. 1 and 2 are circular in shape, any shape suitable for receipt of a candle may be used. For example, the shape of the orifice 14 and bore 20 may be triangular, square, rectangular, oval, octagonal, or pentagonal. The orifice 14 and bore 20 may be any shape which retains a candle. Although the orifice 14 is typically the same shape as the bore 20, this is not essential and the orifice 14 and bore 20 may be different shapes in other embodiments of the invention.

As stated, the candle holder 10 comprises a suction cup 13. Referring to FIG. 2, the suction cup 13 is centered on axis A-A. Being relatively thinner than the body 11 allows the suction cup 13 to exhibit elasticity while moving between an unflexed state and a flexed state. FIG. 2 shows the suction cup 13 in its unflexed state with the bottom side 22 forming a concave shape. Having axially opposite top and bottom sides, 21 and 22, the suction cup 13 is configured to be pressed against and adhere to smooth surfaces in its flexed state. In the described embodiment of the candle holder 10, the diameter of the suction cup 13 is larger than the diameter of the face 12 to increase support of the body 11 and stability for supporting a candle.

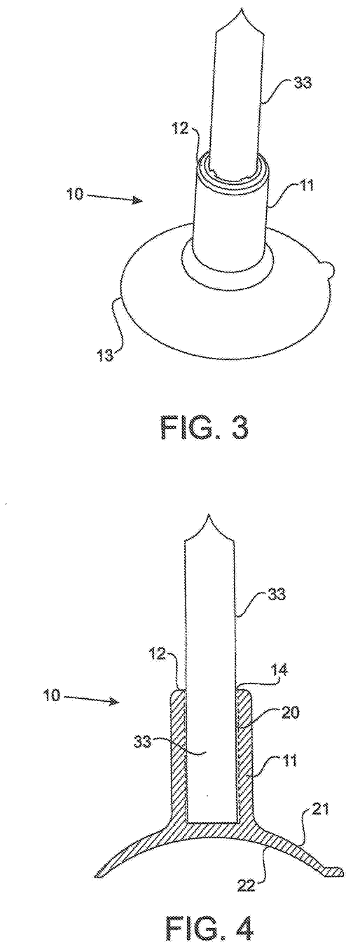

FIGS. 3 and 4 depict the candle holder 10 with a candle 33 inserted into the holder's bore 20. Once inserted, the holder's body 11 acts to support the candle 33 in an upright position inside the bore 20.

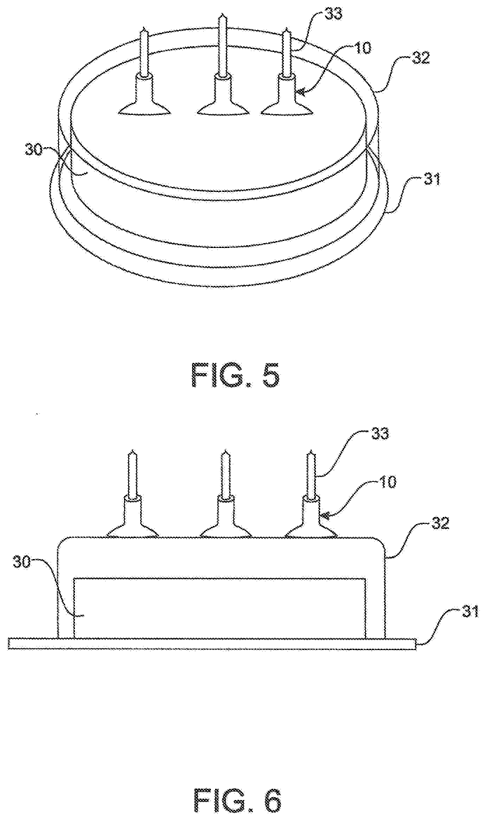

FIGS. 5 and 6 are top and side perspective views, respectively, of a cake 30 sitting on a plate 31. A cake cover 32 is positioned over the cake 30. The cover 32 is that which you would find when purchasing the cake from a grocery store or bakery or that which would find in a home kitchen. Cake covers are commonly made from plastic or glass, giving them a smooth surface that accommodates the suction cup of the present invention.

As shown in FIGS. 5 and 6, the suction cup 13 functions to secure the candle holder 10 in place on the cover 32. As the candle holder 10 is pressed onto a cake cover 32, the air between the suction cup's bottom side 22 and the cover 32 is forced out, creating a vacuum. Although it may be advantageous to insert the candle 33 into the candle holder 10 prior to suctioning it to the cake cover 32, the candle 33 may be inserted into the candle holder 10 after suctioning it to the cake cover 32. Once the candle 33 is lit, it may be blown out without directly exposing the cake 30 to the blower's germs.

As stated, the preferred embodiment of the candle holder 10 is sized to receive, support, and display a standard, round birthday candle. The candle holder's bore 20 is not limited to these dimensions or configuration and may be produced to fit different sizes and shapes of candles, figurines, or decorative items.

As alternate bore configurations may be desirable, is also possible in another embodiment of the invention for the bore to have a tapered configuration. In this embodiment, the orifice 14 would have a first diameter and the bore 20 would narrow to a second, smaller diameter as it enters the body 11. This embodiment allows the candle holder 10 to be used with candles of different sized diameters. A candle with a larger diameter would intersect the body 11 at a shallower depth inside the bore 20 than a candle with a smaller diameter. The tapered bore configuration ensures a snug fit for either size diameter candle in this example.

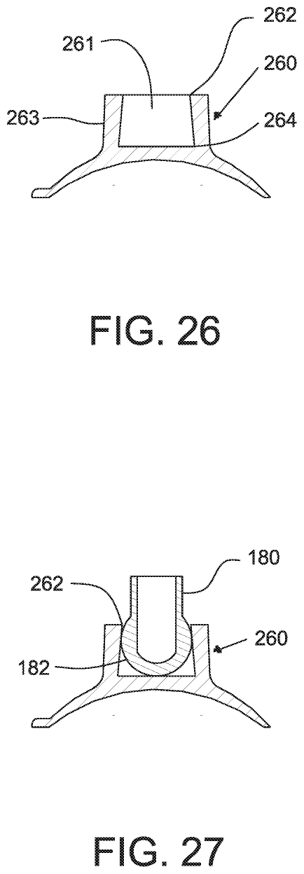

Instead of having a tapered, narrowing bore, one embodiment of the invention has a reverse taper. The reverse taper candle holder 260 is illustrated in FIG. 26. The reverse tapered bore 261 begins at an orifice 262 with a first diameter. From the orifice 262, the bore 261 broadens as it enters downward into the body 263 before reaching a bottom stop 264. The bottom stop 264 has a second diameter that is larger than the orifice's 262 diameter. This embodiment, referred to as a reverse tapered configuration, permits the candle holder to receive and support optional articulating attachments set out below.

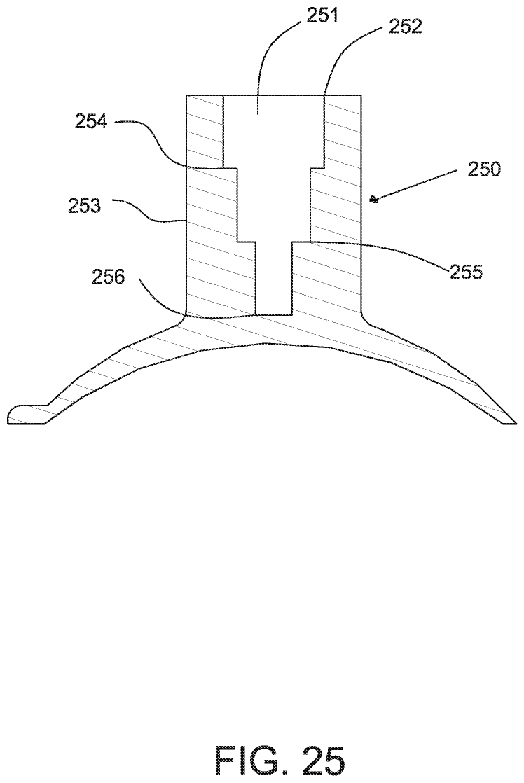

Another bore configuration designed to universally accommodate candles having different diameters is shown in FIG. 25. The universal bore configuration is built exactly like the candle holder described above except for having a different bore configuration. In other words, it comprises a body 253, a face, and a suction cup, but has a different shaped bore 251. The universal holder's bore 251 begins with a first diameter at an orifice 252 on its face. From the orifice 252, the bore 251 extends straight downward into the body 253 on a plane parallel to that of the body 253. At a first distance down the bore 251 a first step 254 forms by narrowing to a second diameter that is smaller than the orifice's 252 diameter. From the first step 254, the bore 251 continues downward into the body 253 on a plane parallel to that of the body 253. At a second distance down the bore 251 a second step 255 forms by narrowing to a third diameter that is smaller than the first step's 254 diameter. From the second step 255, the bore 251 continues downward into the body 253 on a plane parallel to that of the body 253. At a third distance down the bore 251 a bottom stop 256 forms in a plane perpendicular to that of the body 253 and has a fourth diameter that is smaller than the universal bore's 251 diameter at its second step 255.

Like the tapered bore configuration, the universal bore is configured to allow the candle holder to be used with candles of different sized diameters. A candle with a larger diameter would intersect the body 253 at a shallower step, the first step 254 for example, than a candle with a smaller diameter. In this example the candle with a smaller diameter may be inserted farther into the bore 251 and may intersect with the body 253 at its second step 255 or reach the bottom stop 256 depending on the candle's diameter. Thus, the smaller diameter candle would insert deeper into the universal bore 251 until it encountered a step having a similar or slightly smaller diameter, giving the candle a snug fit. While the universal bore configuration is described and illustrated with two steps, it is not intended to be limited and may include a multitude of steps in other embodiments.

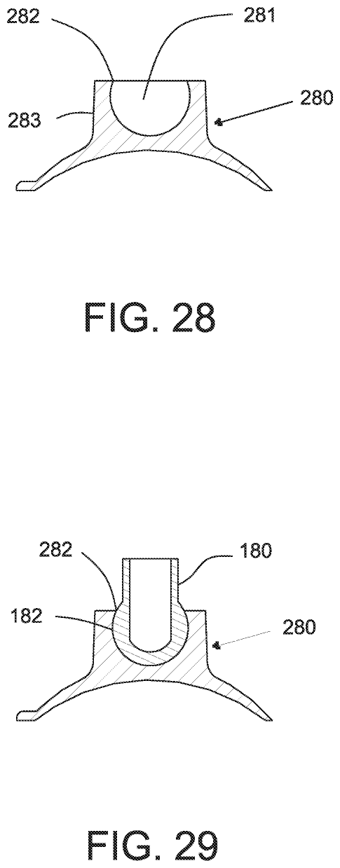

In yet another optional bore configuration shown in FIG. 28, the bore 281 opens from the orifice 282 and extends downward into the body 283 in a spherical shape, creating a spherical shell inside the body 283. Like the reverse tapered bore configuration, this spherical bore configuration permits the candle holder to receive optional attachments set out below.

In another embodiment of the invention where adaptation to different candle dimensions is needed, the body forms a plurality of barbs extending into the bore. The barbs may be distributed and aligned horizontally in a circular pattern around the bore. Alternatively, the barbs may be distributed and aligned vertically, or parallel with the body. With either configuration, the purpose of the barbs is to create resistance against the exterior of a candle inserted into the bore. In turn, the resistance aids in securing the candle inside the candle holder much like the burred adapter described below.

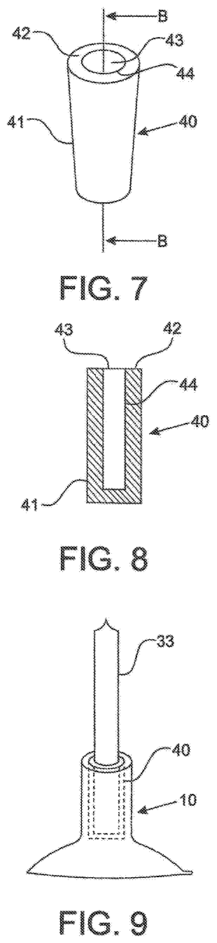

As shown in FIGS. 7 through 9, the candle holder 10 may be used with a smaller diameter candle adapter 40. The smaller diameter candle adapter 40 comprises a body 41 and face 42. The adapter's face 42 lies flat in a plane perpendicular to the adapter's body 41. At its central portion along axis B-B, the face 42 forms an orifice 43 for reception of a candle. As shown in FIG. 8, a bore 44 begins at the adapter's orifice 43 and extends downward into the adapter's body 41. Like the adapter's body 41, the adapter's bore 44 is vertical, circular, and runs parallel to axis B-B. The adapter's bore 44 is configured and sized to receive a smaller diameter candle. Optimally, the bore's 44 diameter is slightly smaller than the candle's diameter. This configuration and the adapter's 40 elasticity promote deflection in the adapter's body 41 which acts to secure the candle in the adapter's bore 44.

Essentially, the adapter's orifice 43 and bore 44 function like the candle holder's orifice 14 and bore 20 except that they are adapted to receive a smaller diameter candle. In turn, the adapter's body 41 is inserted into the candle holder's orifice 14 and bore 20 in the same manner a thicker candle would be. Although the preferred embodiment of the smaller diameter candle adapter 40 is configured to receive a cylindrical candle, the adapter's orifice 43 and bore 44 could be arranged and built to receive any shape of candle.

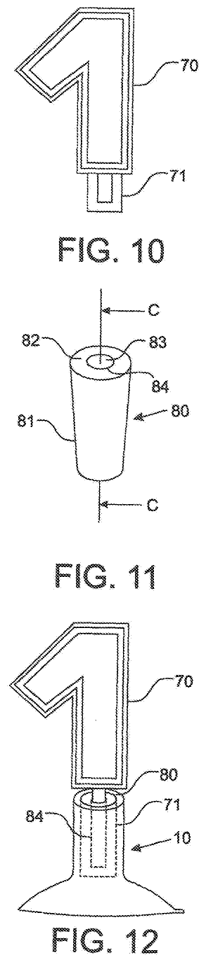

As some birthday and decorative candles have a spiked base 71, shown in FIG. 10, for insertion into a cake, yet another candle holder adapter is available for reception of a spiked candle 70 and insertion into the candle holder's orifice 14 and bore 20. FIG. 11 depicts the spiked candle adapter 80. The spiked candle adapter 80 comprises a body 81 and a face 82. Like the smaller diameter candle adapter 40 configuration, the spiked adapter's face 82 lies flat in a plane perpendicular to the spiked adapter's body 81. At its central portion along axis C-C, the face 82 forms an orifice 83 for reception of a candle spike 71.

A bore 84 begins at the spiked candle adapter's orifice 83 and extends downward into the adapter's body 81. Like the adapter's body 81, the adapter's bore 84 is vertical, circular, and runs parallel to axis C-C. The bore 84 is configured to receive the spike 71 on the bottom of a spiked candle 70 as depicted in FIG. 12. Essentially, the spiked adapter's orifice 83 and bore 84 function like the candle holder's orifice 14 and bore 20 except they are adapted to receive a spiked candle 70. In turn, the spiked adapter's body 81 is inserted into the candle holder's orifice 14 and bore 20 in the same manner a thicker candle would be.

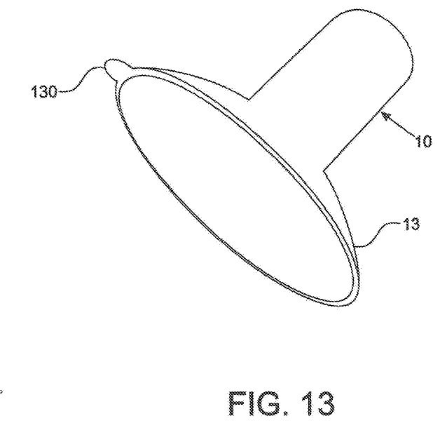

In some instances, the suction cup may create a stronger vacuum making the candle holder difficult to remove from some cake covers. As shown in FIG. 13 another embodiment of the presented invention includes a pull tab 130. The pull tab 130 extends from the outer edge of the suction cup 13 as a continuous piece of the candle holder 10 giving the user a manual release to remove the suction cup from a cake cover. To release the suction cup 13, the user would pull the tab 130 upwards away from the cake cover.

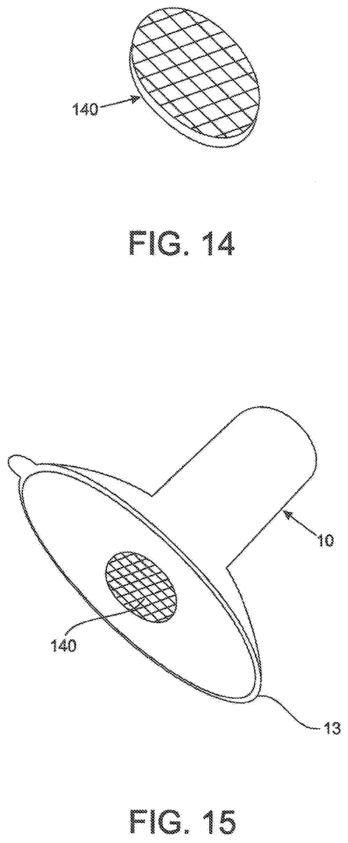

On the other hand, some surfaces are not as receptive as others to vacuum suction cup attachment. In this case double sided adhesive 140, shown in FIG. 14, can be attached to the suction cup's bottom 22 as show in FIG. 15. While the double-sided adhesive 140 would augment the candle holder's 10 ability to stick to a non-smooth surface, the adhesive 140 loses stickiness when removed and would have limited reusability. Additionally, compared to the suction cup 13, the double-sided adhesive 140 could be more difficult to remove from the cake holder.

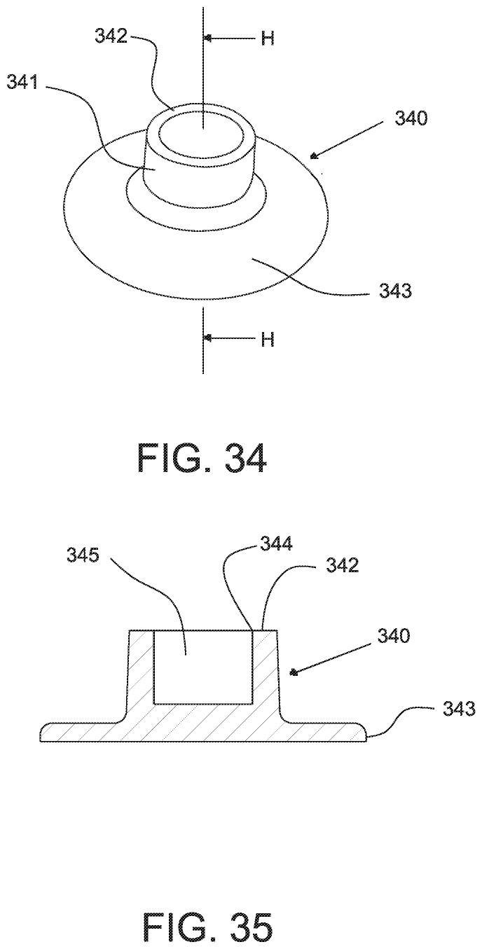

In another embodiment, the double-sided adhesive may be used to replace the vacuum created by the suction cup completely by utilizing a flat base 343 with the candle holder as shown in FIGS. 34 and 35. However, this embodiment introduces limitations on the reusability of the candle holder and the advantages of the one-piece design set out herein. Using double sided adhesive could damage the cake cover upon removing the candle holder after use or for relocation. Moreover, as the double-sided adhesive is reused it will lose tackiness, reducing its lifespan. That said, the flat based candle holder retains some utility as it broadens the applications in which a candle may be securely fastened to a cake cover to fight the spread of germs.

Referring to FIG. 34, the flat base candle holder 340 comprises a body 341, a face 342, and a base 343. The face 342 and base 343 are connected by the body 341 and molded as a one-piece structure. The flat base candle holder 340 is symmetric about an axis, represented as H-H. At its central portion along axis H-H, the face 342 forms an orifice 344 for reception of a candle.

The face 342 is formed from one end of the body 341 opposite the base 343. Moreover, the face 342 lies flat in a plane parallel to the plane on which the base 343 is positioned. As shown in FIG. 35, a bore 345 begins at the orifice 344 and extends downward. The flat base candle holder 340 may utilize a variety of bore configurations, including the straight, tapered, reverse tapered, partially tapered, universal, and spherical configurations detailed herein. The ability to utilize a variety of bore configurations further permits the flat base candle holder to work with a variety of adapters, including the smaller diameter candle, spiked candle, decorative, articulating, through hole, and burred adapters set forth herein.

In use, double sided adhesive 140 is attached to the bottom side, opposite the body, of the flat base candle holder 340. While the adhesive on one side of the adhesive 140 attaches to the candle holder 340, the adhesive on the other side of the adhesive attaches to a cake cover. This configuration secures the flat base candle holder 340 to a cake cover

One advantage of the flat base candle holder 340 is that it may be manufactured from either a soft or hard plastic. Using either plastic, the diameter of any candle or adapter should be slightly larger than the bore of the holder. If the holder is a soft plastic and the adapter is a hard material, pressing the adapter into the holder will stretch the holder's body around the adapter holding it in place. If the holder is made of a hard plastic and the adapter is made of a soft plastic, pressing the adapter into the holder will deform the adapter holding it in place. If both the holder and adapter are made of soft plastic, pressing the adapter into the holder will deform both the holder and adapter holding the adapter in place. The combination of a hard plastic holder and a hard plastic adapter works best with a reverse taper configuration or spherical configuration where the shape of the bore acts to hold the adapter in place rather than relying solely on the deformation characteristics of a soft plastic.

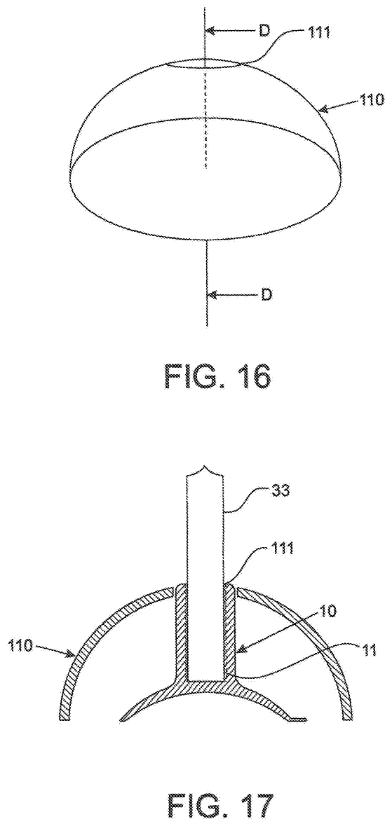

In addition to decorating cakes with candles, a variety of decorative figures are commonly used as cake toppers. Therefore, one embodiment of the current invention is adapted to incorporate a cake topper adapter 110 as shown in FIGS. 16 and 17. The topper adapter 110 can include any personal or commercial design and be shaped as a figure or character similar to commonly used cake toppers. At its central portion along axis D-D, the topper adapter 110 forms an orifice 111 for reception of the candle holder's body 11.

In use, the candle holder's body 11 is inserted, leading with the face 12, through the topper adapter's orifice 111 from the adapter's under side. The topper adapter's orifice 111 is configured and sized to fit over the face 12 and then rest against the outer surface of the body 11. Once resting against the body 11, the topper adapter 110 is displayed on a cake cover like the candle holder 10, using the candle holder's suction cup 13.

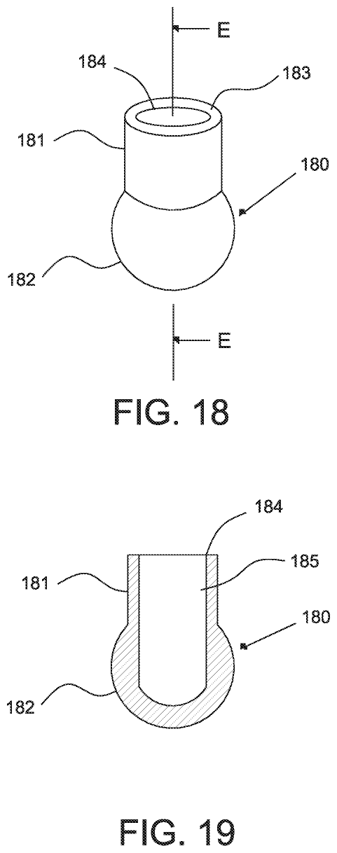

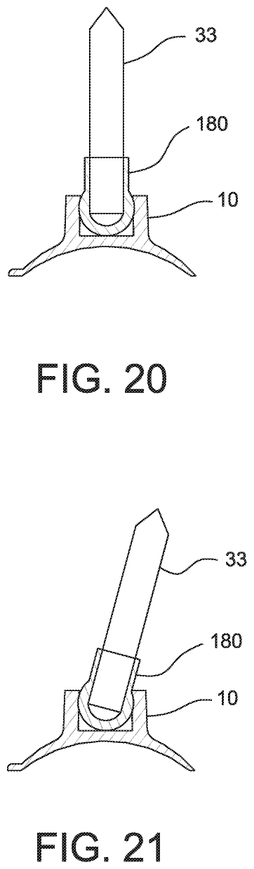

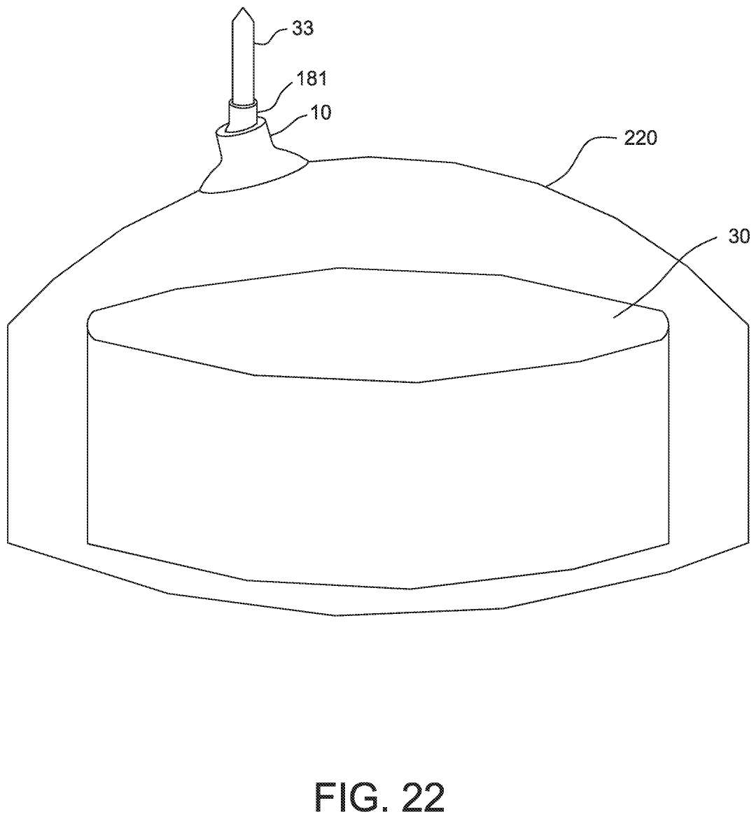

For use on cake covers that have a non-parallel surface, such as a dome shaped cake cover, an articulating adapter may be used with the candle holder to adjust a candle to an upright position. As illustrated in FIG. 18, the articulating adapter 180 comprises a body 181, ball 182, and a face 183. The face 183 and ball 182 are connected by the body 181 and molded as a one-piece structure. The articulating adapter 180 is symmetric about an axis, represented as E-E.

The articulating adapter's face 183 is formed from one end of the body 181 opposite the ball 182. Moreover, the face 183 lies flat on a plane perpendicular to the axis, E-E, extending through the articulating adapter 180. It is not essential that the face 183 is flat any may take on other shapes in other embodiments of the invention.

At its central portion along axis E-E, the articulating adapter's face 183 forms an orifice 184 for reception of a candle. The articulating adapter's orifice 184 is designed to receive a candle like the candle holder's orifice 14 and the orifices associated with its other described adapters. As shown in FIG. 19, a bore 185 begins at the articulating adapter's orifice 184 and extends downward into the body 181. The bore 185 is vertical, circular, and runs parallel to axis E-E. Moreover, the bore 185 has an inner diameter that is designed and sized to receive and support a candle.

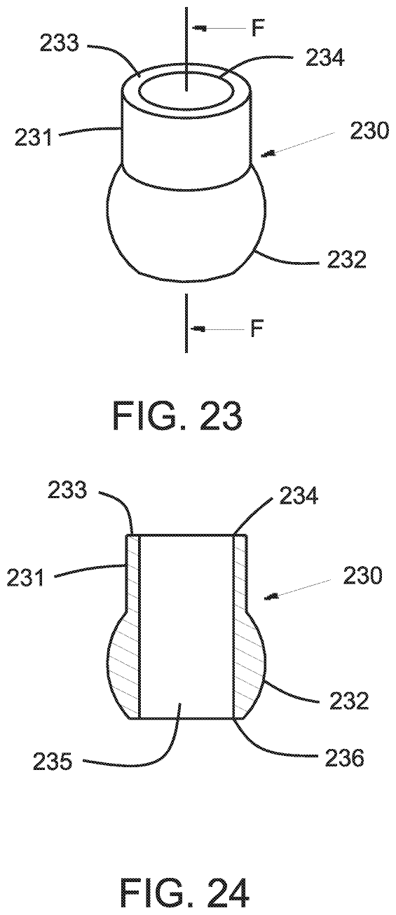

An alternative embodiment of the articulating adapter includes a through hole as shown in FIGS. 23 and 24. The through hole articulating adapter 230 functions in the same manner as the articulating adapter 180 described above, but permits a more efficient manufacturing process. More specifically it can be manufactured using standard ejector sleeves or with a stripper plate mold design.

Like the articulating adapter 180, the through hole adapter 230 comprises a body 231, a ball 232, and a face 233. Moreover, the through hole's face 233 forms on one end of the body 231 opposite the ball 232. Lying flat on a plane perpendicular to the axis, F-F, the face 233 forms an orifice 234 for reception of a candle. As shown in FIG. 24, a bore 235 begins at the articulating adapter's orifice 234 and extends downward into, and through, the body 231 and ball 232. The bore 235 is vertical, circular, and runs parallel to axis F-F. The bore 235 has an inner diameter that is designed and sized to receive and support a candle.

The through hole adapter's ball 232 differs from that of the articulating adapter's ball 182 in that it forms a second orifice 236. The second orifice 236 opens on the opposite side of the through hole adapter 280 than the face 233. With the second orifice 236, the through hole adapter's bore 235 extends all the way through the body 231 and the ball 232.

Both the articulating adapter 180 and the through hole adapter 230 work with the straight bore 20 version of the candle holder 10 as well as the reversed taper bore 261 and spherical bore 281 configurations. When used with a straight bore 20 the ball, 182 or 232, on each of these adapters relies on deflection in the body 11 to secure it in place. To better secure the ball inside the straight bore 20 it is advantageous for the ball, 182 or 232, to have a slightly larger diameter than that of the inside diameter of the bore 20. Given this configuration, the adapter, 180 or 230, is pushed into the candle holder's straight bore 20 causing the body 11 to be elastically deformed. The deflection in the body 11 works to hold the ball, 182 or 232, inside the bore 20 while allowing it to articulate.

When used with the reverse taper bore 261 as shown in FIG. 27, the ball. 182 or 232, should have a diameter larger than the orifice's 262 diameter. Thus, when the ball, 182 or 232, is pushed though the orifice 262 and into place inside the reverse taper bore 261, the bore's 261 configuration acts to secure the ball, 182 or 232, in the candle holder 260.

Similarly, the spherical bore's 281 configuration secures the ball, 182 or 232, in the candle holder 280 as illustrated in FIG. 29. Here, the ball's, 182 or 232, diameter should be sized to fit the spherical shell created inside the body 283 by the bore 281. Given this configuration, the ball's, 182 or 232, diameter is larger than the orifice's 282 diameter. In use, the ball, 182 or 232, is pushed past the smaller orifice 282 and into the spherical bore 281. The orifice's 282 and bore's 281 configurations work to secure the ball, 182 or 232, inside the body 283 while permitting it to articulate.

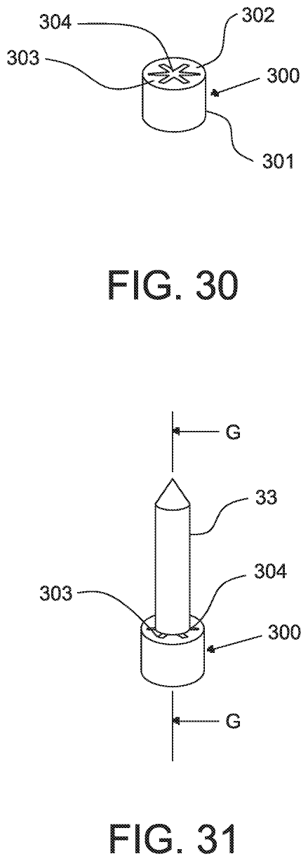

Another adapter designed to facilitate reception of different sized candles into candle holder is shown in FIG. 30. This universal adapter 300 comprises a body 301 and a face 302. Having a cylindrical shape, the body 301 is centered on an axis, G-G, as shown in FIG. 31. At one end of the body 301, the face 302 extends from the body 301 inward toward the axis G-G. More specifically, the face 302 lies in a plane perpendicular to the body 301 and axis G-G. Beginning at the outside of the face 302 and extending inward toward axis G-G, the face 302 forms a plurality of barbs 303. The ends of the barbs 303 form an orifice 304 that opens at the center of the face 302.

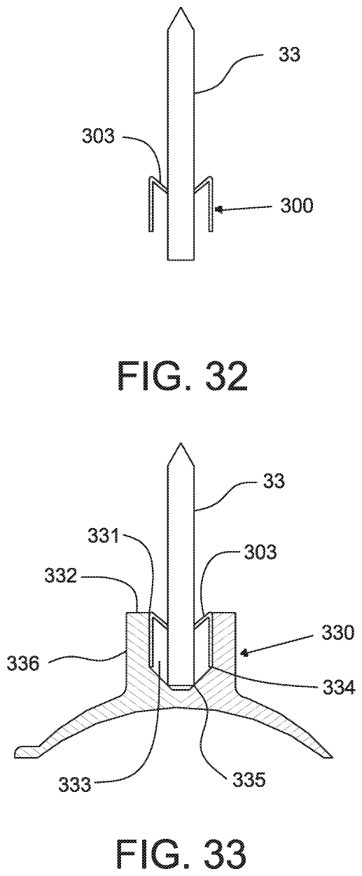

Referring to FIG. 31 which shows the universal adapter 300 in use, the orifice 304 receives a candle 33 by the user pressing the candle 33 from outside the adapter 300 downward through the barbs 303 and into the body 301. To better illustrate the universal adapter's 300 configuration and use, FIG. 32 shows a vertical sectional view of a candle 33 inserted into the hollow adapter's bore 305. The universal adapter's barbs 303 are flexible, flexing downward into the bore 305 as the candle 33 is inserted. In their downwardly flexed position shown in FIG. 31, the barbs 303 create a securing grip on the candle 33.

The universal adapter 300 works best when used with a partially tapered bore configuration, shown in the candle holder 330 illustrated in FIG. 32. In this bore configuration the orifice 331 opens from the face 332 as it does on the standard candle holder described above. Moreover, the orifice 331 has a first diameter. From the orifice 331 a bore 333 extends downward into the body 336. At a first distance into the body 336, the bore 333 reaches a first step 334. The diameter of the bore 333 at the first step 334 is equal to the orifice's 331 diameter. From the first step 334, the bore 333 begins to narrow in diameter as it goes farther down into the body 336. At a second distance into the body 336, the bore 333 reaches a bottom stop 335. The bore's diameter at the bottom stop 335 is smaller than the bore's diameter at the first step 334.

In addition to protecting against viruses and colds, an advantage of the current embodiment of the candle holder 10, is that it can easily be removed from the cake cover 32 by pulling up on the suction cup 13. This is useful for easy rearrangement of candle holders 10 on a cake cover 32 to either create different candle formations or permit a less restricted view of the cake 30 through the cover 32. The easy removal of the suction cup 13 also enables quick cleanup after the candles have been used.

Further advantages of the current invention include its size and ease of manufacture. Because of the candle holder's size and weight, a plurality of candle holders could be displayed on a cake cover at once without weighing down or damaging the cover. Additionally, the invention's size and one-piece design permit efficient, economic manufacture by injection molding.

Finally, a single candle holder could be configured to receive, support, and display a plurality of candles.

It will be apparent to one with skill in the art that the candle holder of the invention may be provided using some or all the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the description without departing from the spirit and scope of the present invention.

What is claimed is:

1. A candle holder, comprising:
a suction cup centrally located on an axis and having opposite top and bottom sides in a plane perpendicular to said axis, said bottom side having a concave shape;
a cylindrical body extending along the axis upward from the top side of said suction cup and forming an end opposite said suction cup;
a face at the end of said body located opposite the suction cup, said face lying flat in a plane perpendicular with said axis;
an orifice forming from the center of said face; and
a bore that extends from said orifice downward into said body.

2. The candle holder of claim 1 wherein said bore is straight, extending vertically into said body parallel to said axis.

3. The candle holder of claim 2 further comprising a smaller diameter candle adapter.

4. The candle holder of claim 2 further comprising a spiked candle adapter.

5. The candle holder of claim 2 further comprising an articulating adapter.

6. The candle holder of claim 2 further comprising a through hole adapter.

7. The candle holder of claim 1 wherein said bore is tapered, narrowing in diameter as it enters the body.

8. The candle holder of claim 1 wherein said bore is reverse tapered, broadening in diameter as it enters the body.

9. The candle holder of claim 8 further comprising an articulating adapter.

10. The candle holder of claim 8 further comprising a through hole adapter.

11. The candle holder of claim 1 wherein said bore has a partial taper configuration.

12. The candle holder of claim 11 further comprising a burred adapter.

13. The candle holder of claim 1 wherein said bore has a universal configuration.

14. The candle holder of claim 1 wherein said bore has a spherical configuration.

15. The candle holder of claim 14 further comprising an articulating adapter.

16. The candle holder of claim 14 further comprising a through hole adapter.

17. The candle holder of claim 1 wherein the candle holder is made of a polymer.

18. The candle holder of claim 1 wherein said body forms a plurality of barbs extending into said bore.

19. The candle holder of claim 1 wherein said suction cup further comprises a tab.

20. The candle holder of claim 1 further comprising a double-sided adhesive piece.

21. The candle holder of claim 1 further comprising a decorative adapter.

22. A candle holder, comprising:
a flat base having opposite top and bottom sides;
a cylindrical body centrally located on an axis extending upward from the top side of said base and forming an end opposite said base;
a face at the end of said body located opposite the base, said face lying flat in a plane perpendicular with said axis;
an orifice a forming from the center of said face;
a bore that extends from said orifice downward into the body; and
a double-sided adhesive piece.
